(19) United States
(12) Patent Application Publication
(10) Pub. No.: US 2020/0388087 A1
(43) Pub. Date: Dec. 10, 2020

(54) APPARATUS FOR DIAGNOSING FAILURE IN VEHICLE AND CONTROL METHOD THEREOF

(71) Applicants: Hyundai Motor Company, Seoul (KR); Kia Motors Corporation, Seoul (KR); Industry-University Cooperation Foundation Hanyang University (IUCF-HYU), Seoul (KR)

(72) Inventor: Kyung Jun Kim, Suwon-si (KR)

(21) Appl. No.: 16/664,077

(22) Filed: Oct. 25, 2019

(30) Foreign Application Priority Data
Jun. 5, 2019 (KR) 10-2019-0066999

(51) Int. Cl. G07C 5/08

(52) U.S. Cl. CPC G07C 5/0808; G07C 5/0825

(57) ABSTRACT

A vehicle comprises: at least one module configured to determine a driving model of the vehicle; a sensor configured to obtain driving information of the vehicle; a controller configured to: determine the driving information corresponding to the driving model, determine whether the at least one module has failed or not based on a comparison of a reference value and a difference between the driving model and the driving information.

### CROSS-REFERENCE TO RELATED APPLICATION(S)

This application is based on and claims priority to Korean Patent Application No. 10-2019-0066999, filed on Jun. 5, 2019 in the Korean Intellectual Property Office, the disclosure of which is incorporated by reference in its entirety.

### TECHNICAL FIELD

The present disclosure relates to a vehicle and a control method for diagnosing a failure of a module in the vehicle.

### BACKGROUND

Autonomous driving technology of a vehicle is a technology in which the vehicle automatically detects a road situation without a driver to control a brake, a steering wheel, an accelerator pedal, and the like.

The autonomous driving technology is a core technology for implementing a smart car. The autonomous driving technology includes Highway Driving Assist (HDA) which is a technology of automatically observing the proper distance between cars, Blind Spot Detection (BSD) which is a technology of recognizing another vehicle during reversing or in a blind spot to sound a warning, Autonomous Emergency Brake (AEB) which is a technology of operating the brakes when a driver fails to recognize another vehicle ahead), Lane Departure Warning System (LDWS), Lane Keeping Assist System (LKAS) which is a technology of preventing departure from a lane without a turn signal, Advanced Smart Cruise Control (ASCC) which is a technology of traveling at a constant speed while observing a predetermined distance between cars, Traffic Jam Assist (TJA), and Parking Collision-Avoidance Assist (PCA), etc.

In order to implement the above-described technologies, the vehicle includes a Global Positioning System (GPS) module and an Around View Monitor (AVM) module.

It is important to determine a reference value for fault diagnosis of the modules for autonomous driving, and therefore, a separate device is required for determining such a reference value.

### SUMMARY

An aspect of the present disclosure provides a vehicle and a control method capable of efficient failure diagnosis by using a sensor of the vehicle to determine a reference value that can be used to diagnose the failure of an autonomous vehicle module.

In accordance with one aspect of the present disclosure, a vehicle comprises: at least one module configured to determine a driving model of the vehicle; a sensor configured to obtain driving information of the vehicle; a controller configured to determine the driving information corresponding to the driving model, and to determine whether the at least one module has failed or not based on a comparison of a reference value and a difference between the driving model and the driving information.

The vehicle may further comprise a display.

The controller may be configured to output a message to the display when determined that a failure occurs in the at least one module.

The at least one module may comprise an AVM module, and

The controller may be configured to determine whether the AVM module has failed based on a comparison between each of a lateral acceleration and a yaw rate of a driving model determined by the AVM module and a lateral acceleration and a yaw rate included in the driving information.

The at least one module may comprise a Global Positioning System (GPS) module, and the controller may be configured to determine whether the GPS module has failed based on a comparison between each of a longitudinal speed and a yaw angle of a driving model determined by the GPS module and a longitudinal speed and a yaw angle included in the driving information.

The sensor may comprise a wheel speed sensor and an inertial sensor.

The reference value may be determined based on variable values of the driving information corresponding to the driving model.

The sensor may comprise a plurality of sensor modules, and the controller may be configured to determine the driving information by comparing a first state variable determined based on at least one of the plurality of sensor modules and a second state variable determined based on a remaining one or more of the plurality of sensor modules.

The controller is configured to control to drive the vehicle excluding the driving model generated by the at least one module when determined that a failure has occurred in the at least one module.

In accordance with another aspect of the present disclosure, a control method of a vehicle comprises: determining a driving model of the vehicle, obtaining driving information of the vehicle; determining the driving information corresponding to the driving model; and determining whether at least one module has failed or not based on a comparison of a reference value and a difference between the driving model and the driving information.

The control method of the vehicle may further comprise outputting a message to a display when determined that a failure occurs in the at least one module.

The at least one module may comprise an AVM module, and the determining of whether the at least one module has failed may comprise determining whether the AVM module has failed based on a comparison between each of a lateral acceleration and a yaw rate of a driving model determined by the AVM module and a lateral acceleration and a yaw rate included in the driving information.

The at least one module may comprise a Global Positioning System (GPS) module, and the determining of whether the at least one module has failed may comprise determining whether the GPS module has failed based on a comparison between each of a longitudinal speed and a yaw angle of a driving model determined by the GPS module and a longitudinal speed and a yaw angle included in the driving information.

The reference value may be determined based on variable values of the driving information corresponding to the driving model.

The determining of whether the at least one module has failed may be comprised of determining the driving information by comparing a first state variable determined based on at least one of the plurality of sensor modules and a second state variable determined based on a remaining one or more of the plurality of sensor modules.

The control method of the vehicle may further comprise driving the vehicle excluding the driving model generated by the at least one module when determined that a failure has occurred in the at least one module.

### BRIEF DESCRIPTION OF THE DRAWINGS

These above and/or other aspects of the disclosure will become apparent and more readily appreciated from the following description of exemplary embodiments, taken in conjunction with the accompanying drawings in which:

FIG. 1 is a control block diagram of a vehicle according to an exemplary embodiment of the present disclosure.

FIG. 2 is a view for explaining a group observer structure according to an exemplary embodiment of the present disclosure.

FIG. 3 is a diagram illustrating an AVM module according to an exemplary embodiment of the present disclosure.

FIG. 4 is a view for explaining a GPS module according to an exemplary embodiment of the present disclosure.

FIG. 5 is a diagram for describing an operation of learning a reference value according to an exemplary embodiment of the present disclosure.

FIG. 6 is a flowchart according to an exemplary embodiment of the present disclosure.

### DETAILED DESCRIPTION

Like numbers refer to like elements throughout this specification and in the drawings. This specification does not describe all components of the embodiments, and general information in the technical field to which the present disclosure belongs or overlapping information between the embodiments is also not described. The terms “part,” “module,” “element,” and “block,” as used herein, may be implemented as software or hardware, and in the disclosed embodiments, a plurality of “parts,” “modules,” “elements,” and “blocks” may be implemented as a single component, or a single “part,” “module,” “element,” and “block” may include a plurality of components.

It will be understood that when a component is referred to as being “connected” to another component, it can be directly or indirectly connected to the other component. When a component is indirectly connected to another component, it may be connected to the other component through a wireless communication network.

It will be understood that the terms “includes,” “comprises,” “including,” and/or “comprising,” when used in this specification, specify the presence of a stated component, but do not preclude the presence or addition of one or more other components.

It will be understood that, although the terms first, second, third, etc. may be used herein to describe various components, these components should not be limited by these terms. These terms are only used to distinguish one component from another.

It is to be understood that the singular forms “a,” “an,” and “the” include plural referents unless the context clearly dictates otherwise.

Reference numerals used in operations are provided for convenience of description, without describing the order of the operations. The operations can be executed in an order different from the stated order unless a specific order is definitely specified in the context.

Hereinafter, the operation principle and embodiments of the present disclosure are described with reference to the accompanying drawings.

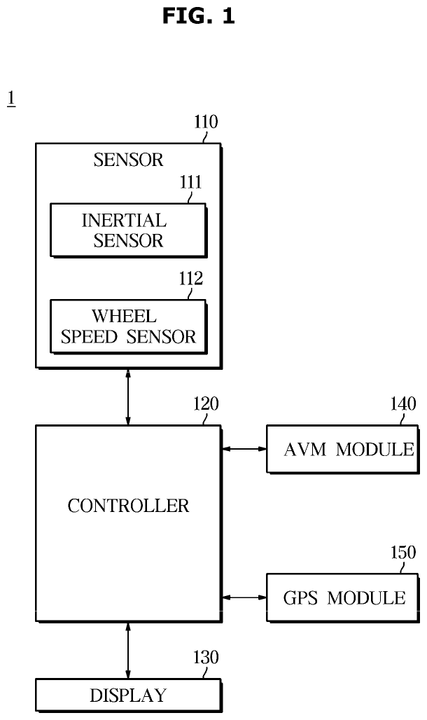

FIG. 1 is a control block diagram of a vehicle according to an exemplary embodiment of the present disclosure.

Referring to FIG. 1, a vehicle according to an exemplary embodiment of the present disclosure may include a sensor 110, a display 130, an Around View Monitor (AVM) module 140, and a Global Positioning System (GPS) module 150.

The AVM module 140 and the GPS module 150 may configure at least one module for determining a driving model of the vehicle.

The driving model may refer to driving state information derived by a processor included in each of the modules based on information obtained by each of the modules.

The AVM module is a module that creates a top view screen as if an image of the vehicle was taken from the top of a navigation screen using four cameras, one at the bottom of front and rear and left and right side mirrors of the vehicle.

Using an AVM system, a driver can grasp a situation around the vehicle at a glance and safely park or pass a narrow road.

In addition, the AVM module 140 provided in the vehicle in autonomous driving may form the driving model of the vehicle and provide it to a controller 120 provided in the vehicle.

Specifically, the AVM module 140 may derive a lateral acceleration and a yaw rate of the vehicle through a front camera and a side camera. The controller 120 may determine whether the AVM module 140 has failed based on the lateral acceleration and the yaw rate. The controller 120 may be a processor or a microprocessor such as a computer, a central processing unit (CPU), or an electronic control unit (ECU).

The GPS module 150 may compare sub-state variables between a track used in the vehicle and a track (Dead Reckoning). The GPS module 150 may include a processor for diagnosing a failure.

In addition, the GPS module 150 provided in the vehicle in autonomous driving may form the driving model of the vehicle and provide the driving model to the controller 120 provided in the vehicle.

Specifically, the AVM module 140 may derive the lateral acceleration and the yaw rate of the vehicle through the front camera and the side camera.

The controller 120 may determine whether or not a failure of the AVM module 140 occurs based on the lateral acceleration and the yaw rate.

In addition, the GPS module 150 may use a residual compared to an error rms (root mean square) value of Global Coordinates, a longitudinal speed of the vehicle, and a yaw angle as the residual.

The controller 120 may determine whether a failure of the GPS module 150 occurs based on this.

The sensor 110 may obtain the driving information of the vehicle.

The sensor 110 may include a plurality of sensor modules.

The driving information may include longitudinal and lateral accelerations, the yaw rate, and longitudinal and lateral speeds of the vehicle.

The sensor 110 may include an inertial sensor 111 (Inertial Measurement Unit, IMU) and a sensor in a wheel.

The IMU may refer to a device for measuring a speed and direction of the vehicle, gravity, and acceleration. The IMU may be implemented by using an accelerometer, an oximeter, a geomagnetic machine, and an altimeter to recognize the movement of pedestrians and moving objects. The IMU provided in the vehicle may be configured as a three-axis IMU for deriving the longitudinal acceleration, the lateral acceleration and the yaw rate of the vehicle.

A wheel speed sensor 112 installed on each of front and rear four wheels can detect a rotational speed of the wheels by the change of a magnetic line in a tone wheel (tone wheel) and the sensor.

According to one embodiment, the sensor in the wheel may be provided in a vehicle electronic stability control (ESC) system.

The wheel speed sensor 112 may derive a speed and an acceleration of the vehicle based on the measured wheel.

The display 130 may output a message if it is determined that a failure has occurred in at least one of the modules. The display 130 is not limited as long as the device outputs a warning message.

According to an exemplary embodiment of the present disclosure, the display 130 may be provided as a display device.

The display device may be a Cathode Ray Tube (CRT), a Digital Light Processing (DLP) panel, a Plasma Display Panel (PDP), a Liquid Crystal Display (LCD) panel, an Electroluminescent (EL) panel, an Electrophoretic Display (EPD) panel, an Electrochromic Display (ECD) panel, a Light Emitting Diode (LED) panel, an Organic Light Emitting Diode (OLED) panel, etc., but is not limited thereto.

The controller 120 may determine the driving information corresponding to the driving model, and determine whether the at least one module has failed based on a difference between the driving model and the driving information and a reference value.

The driving model may refer to a driving situation of the vehicle derived by the above-described model.

The driving information may refer to the driving situation of the vehicle derived based on the information obtained by the sensor 110 described above.

The controller 120 may output a message to the display 130 when it is determined that a failure occurs in the at least one module.

The controller 120 may compare the lateral acceleration and the yaw rate of the driving model determined by the AVM module 140 and the lateral acceleration and the yaw rate included in the driving information, respectively.

The controller 120 may determine whether the AVM module 140 has failed based on this.

The controller 120 may compare the longitudinal speed and the yaw angle of the driving model determined by the GPS module 150 and the longitudinal speed and the yaw angle included in the driving information, respectively.

The controller 120 may determine whether the GPS module 150 has failed based on comparison results.

The controller 120 may compare the specific state variable constituting the driving model derived from the module with the state variable derived from the information obtained from the sensor provided by an internal sensor of the vehicle.

The controller 120 may determine that a failure has occurred in the at least one of the modules when the comparison value exceeds a threshold value.

The reference value may be determined based on learning of a variable value of the driving information corresponding to the driving model. A detailed description thereof will be described later.

The controller 120 may determine the driving information by comparing a first state variable determined based on at least one of the plurality of sensor modules with a second state variable determined based on a remaining one or more of the plurality of sensor modules.

This observation structure may be referred to as a generalized observer structure (Generalized Observer Scheme) and will be described in detail later.

If it is determined that a failure has occurred in the at least one of the modules, the controller 120 may control the vehicle to run by excluding the driving model generated by the at least one module.

For example, when the controller 120 controls the autonomous driving, when it is determined that a failure occurs in the AVM module 140, the autonomous driving may be performed by removing the AVM module 140 in the autonomous driving.

The controller 120 performs the above-described operation using a memory (not shown) that stores data for an algorithm or a program reproducing the algorithm for controlling the operation of components in the vehicle, and data stored in the memory. It may be implemented by a processor (not shown). In this case, the memory and the processor may be implemented as separate chips. Alternatively, the memory and the processor may be implemented in a single chip.

At least one component may be added or deleted to correspond to the performance of the components of the vehicle. In addition, it will be readily understood by those skilled in the art that the mutual position of the components may be changed corresponding to the performance or structure of the system.

Each component shown in FIG. 1 refers to a hardware component executed by software and/or a field programmable gate array (FPGA) and an application specific integrated circuit (ASIC).

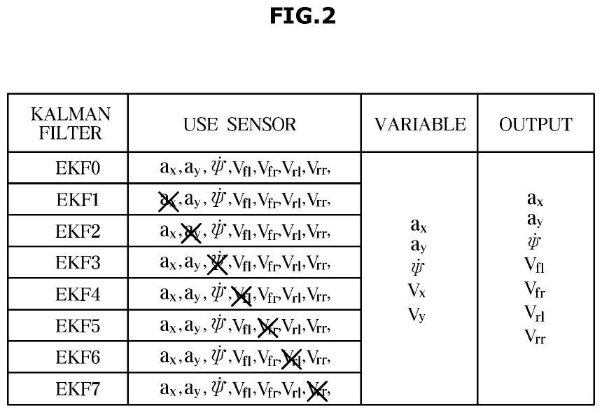

FIG. 2 is a view for explaining a group observer structure according to an exemplary embodiment of the present disclosure.

Referring to FIG. 2, the sensor 110 may include a sensor in a wheel and an inertial sensor.

The wheel speed sensor 112 may measure the speed of a front left wheel Vfl, a front right wheel Vfr, a rear left wheel Vrl, and a rear right wheel Vrr.

The inertial sensor 111 may obtain a longitudinal acceleration ax, a lateral acceleration ay, and a yaw rate \dot{Ψ}.

The controller 120 may derive the acceleration ax, the lateral acceleration ay and the yaw rate \dot{Ψ}, and a dependent degree Vx, and a transverse speed Vy of the vehicle based on the above-described driving information.

The controller 120 may form a generalized observer structure as described below.

The controller 120 may use all the measured values except the one sensor configured using an extended Kalman filter as an input, and output all the values including the values of the excluded sensors.

When the controller 120 is applied to a sensor excluded from the Kalman filter, the controller 120 may detect a failure by not applying the failure to the Kalman filter from which the sensor is excluded.

FIG. 2 is illustrates an operation of detecting a failure based on the longitudinal acceleration in each of the Kalman filters.

For example, an EKF1 Kalman filter does not measure the longitudinal acceleration value, but can determine the longitudinal acceleration (ax) based on other values.

A sensor that includes each of the Kalman filters may be defined as a sensor module.

In FIG. 2, a state variable may be defined as the state variable determined based on a first state variable EKF1 determined based on at least one of the plurality of sensor modules. EKF2 and EKF3 described below may refer to a second state variable determined based on a remaining one or more of the plurality of sensor modules.

In the EKF2, without measuring the lateral acceleration, it is possible to estimate a lateral acceleration value using another sensor value.

The controller 120 may perform a fault diagnosis by comparing the lateral acceleration value estimated by the EKF2 and a lateral acceleration measurement value output from the IMU.

In the EKF3 it is possible to measure a species acceleration value and determine the seed acceleration (ax) without measuring a urine rate.

This operation may continue up to EKF7. In this case, if the longitudinal acceleration derived based on the EKF2 is different from the longitudinal acceleration derived through the other Kalman filters, it may be judged that a failure has occurred in the sensor measuring the lateral acceleration.

However, in the case of the wheel, the propagation of a failure may occur when reflected in the model.

The controller 120 may perform a residual evaluation in consideration of both the residual of the corresponding sensor and other state variables in the EKF like the IMU.

According to an exemplary embodiment, a total of seven state variables may be output to each of the EKFs.

The IMU may determine a corresponding one of the state variables corresponding to each of the EKF variables used for the failure determination.

On the other hand, because the sensor in the wheel is provided with front right, front left, rear right and rear left sensors, it is required to check the residual of the four state variables in order to determine the occurrence of a failure.

In this case, when the controller 120 determines a reference value used in determining a failure of at least one of the modules provided in the vehicle, the controller 120 may implement an operation excluding the sensor from which the longitudinal acceleration is obtained, and the derived information.

On the other hand, the operation described in FIG. 2 is only an exemplary embodiment for explaining the operation of the present disclosure and there is no limitation in the operation of determining the reference value based on the group observer structure.

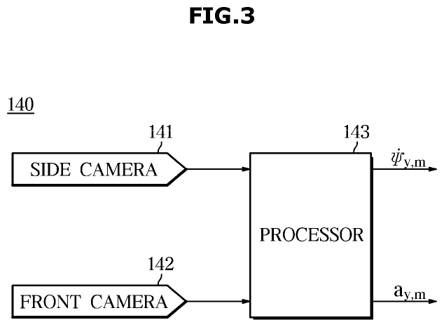

FIG. 3 is a diagram illustrating an AVM module according to an exemplary embodiment of the present disclosure.

As described above, at least one of the modules may include the AVM module 140.

The controller 120 compares the lateral acceleration and the yaw rate of the driving model determined by the AVM module 140 and the lateral acceleration and the yaw rate included in the driving information, respectively, to determine whether the AVM module 140 is broken.

The AVM module 140 may include a side camera 141 and a front camera 142. In addition, a processor 143 included in the AVM module 140 may derive the yaw rate and the lateral acceleration based on this.

Specifically, the AVM module 140 may calculate the yaw rate and a road curvature by modeling a road with the front camera 142.

The AVM module 140 may model the road using the front camera 142, calculate the yaw rate and the road curvature, and transmit the input to a Lateral Error Dynamics. The AVM module 140 may estimate an internal state of the vehicle by measuring a lateral distance error (Lateral Distance Error) with the road by using a left or right camera.

The relationship between the lateral acceleration derived from the driving model derived by the AVM module 140 and the lateral acceleration determined based on the sensor 110 provided in the vehicle may be expressed by Equation 1 below.

a_{y,EKF}−a_{y,M}>R1 [Equation 1]

a_{y,EKF} may refer to the lateral acceleration derived based on the sensor 110, a_{y,M} may refer to the lateral acceleration derived by the AVM module 140, and R1 refers to a reference value.

The controller 120 may determine that a failure occurs in the AVM module 140 when a difference between ay_{,EKF} and a_{y,M} exceeds the reference value.

The relationship between the yaw rate derived from the driving model derived by the AVM module 140, the yaw rate determined based on the sensor 110 provided in the vehicle, and a reference value may be expressed by Equation 2 below.

\dot{Ψ}_{y,EKF}−\dot{Ψ}_{y,M}>R2 [Equation 2]

\dot{Ψ}_{y,EKF} may refer to the lateral acceleration derived based on the sensor 110, and \dot{Ψ}_{y,M} may refer to the lateral acceleration derived by the AVM module 140.

R2 may refer to a reference value.

When the difference between \dot{Ψ}_{y,EKF} and \dot{Ψ}_{y,M} exceeds the reference value, the controller 120 may determine that a failure occurs in the AVM module 140.

As described above, the controller 120 may output a warning message to the display 130 or exclude the driving model generated by the AVM module 140 to drive the vehicle when it is determined that a failure occurs in the AVM module 140.

The operation described in FIG. 3 is only an exemplary embodiment of the present disclosure, and there is no limitation in the operation of determining whether a failure of each of the modules occurs by comparing output values derived by each of the modules.

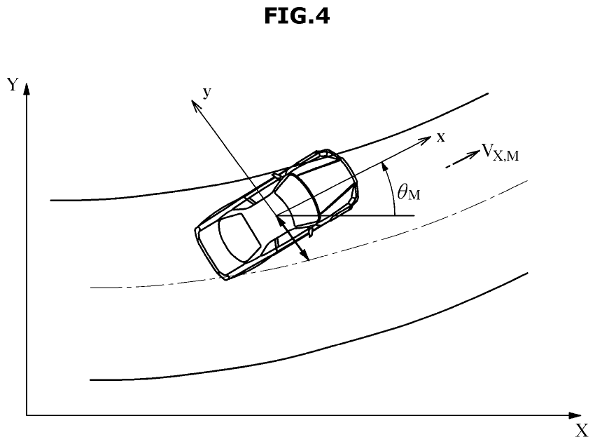

FIG. 4 is a view for explaining a GPS module according to an exemplary embodiment of the present disclosure.

Referring to FIG. 4, in the case of the GPS module 150, a lower state variable may be compared between a system used for precision positioning and a track including a vehicle internal sensor (Dead Reckoning) and a track of a system for performing the precision positioning.

The GPS module 150 may determine a failure.

In the failure diagnosis, the GPS module 150 may perform a controller coordinate comparison, a yaw angle comparison, and a dependency comparison.

The GPS module 150 may adjust Q (Process Noise Covariance) and R (Measurement Noise Covariance) of an Extended Kalman Filter to weight the vehicle model in designing an observer for fault diagnosis.

The GPS module 150 may be designed to detect a failure occurring.

The controller 120 may compare the longitudinal speed and the yaw angle of the driving model determined by the GPS module 150 with the longitudinal speed and the yaw angle included in the driving information, respectively.

The GPS module 150 may determine whether the GPS module 150 has failed.

The relationship between the yaw angle derived from the driving model of the GPS module 150, the yaw angle determined based on the sensor 110 provided in the vehicle, and the reference value may be expressed by Equation 3 below.

ψ_{EKF}−ψ_{M}>R3 [Equation 3]

ψ_{EKF} may refer to the yaw angle derived based on the sensor 110, ψ_{M} may refer to the yaw angle derived by the GPS module 150, and R3 may refer to a reference value.

The controller 120 may determine that a failure occurs in the GPS module 150 when the difference between ψ_{EKF} and ψ_{M} exceeds the reference value.

The relationship between the longitudinal speed derived from the driving model of the GPS module 150, the longitudinal speed determined based on the sensor 110 provided in the vehicle, and the reference value may be expressed by Equation 4 below.

V_{x,EKF}−V_{x,M}>R4 [Equation 1]

Vx, EKF may refer to the longitudinal speed derived based on the sensor 110, Vx, M may refer to the longitudinal speed derived by the GPS module 150, and R4 refers to a reference value.

The controller 120 may determine that a failure occurs in the GPS module 150 when a difference between V_{x,EKF} and V_{x,M} exceeds the reference value.

On the other hand, the above-described yaw angle and the variation of the longitudinal speed residual used to determine the failure of the GPS may be derived from the yaw rate and the longitudinal acceleration acquired by the in-vehicle sensor.

Thus, the controller may use the in-vehicle sensor value when determining each reference value.

In addition, the controller 120 may determine whether a failure occurs in the GPS module 150 based on an error value of global coordinates of the GPS module 150.

The controller 120 may output a warning message to the display 130 or exclude the driving model generated by the GPS module 150 to drive the vehicle when it is determined that a failure occurs in the GPS module 150.

On the other hand, the operation described in FIG. 4 is merely an exemplary embodiment of the present disclosure, and there is no limitation in the operation of determining whether a failure of each of the modules occurs by comparing output values derived by each of the modules.

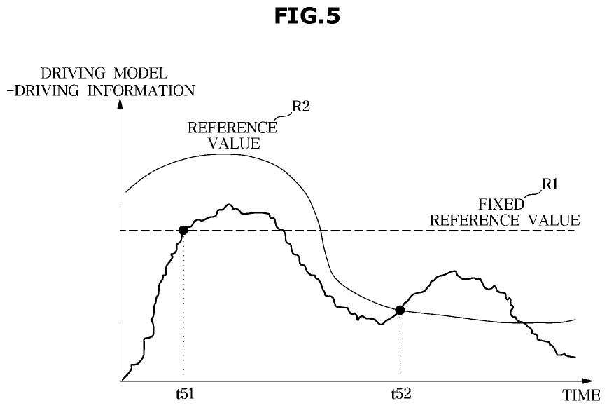

FIG. 5 is a diagram for describing an operation of learning a reference value according to an exemplary embodiment of the present disclosure.

Each of the modules of the vehicle may have a difference in state estimation and actual value due to uncertainty and disturbance of the model.

In addition, since autonomous vehicles are exposed to various environments in comparison with other systems, there may be difficulty in accurately diagnosing the failure of each of the modules with a fixed reference value.

The controller 120 may be determined based on a variable value of the driving information corresponding to the driving model derived by each of the modules.

In detail, the controller 120 may derive a reference value using machine learning and determine a reference value reflecting the state variable characteristics of the vehicle's surroundings. Here, the term “machine learning” may refer to, for example, a method of data analysis that automates analytical model building.

According to an exemplary embodiment of the present disclosure, the controller 120 may determine a reference value through machine learning by reflecting a steering angle and a longitudinal velocity acting as main inputs to a transverse characteristic of the vehicle.

Referring to FIG. 5, in a case of t51, when a fault is diagnosed based on a fixed reference value R1, it may be determined that a failure occurs because a difference between the state value of the driving model and the driving information exceeds the reference value.

When the controller 120 diagnoses a failure based on a learning reference value R2, the controller 120 does not determine that the failure has occurred because the difference between the state values of the driving model and the driving information does not exceed the reference value.

On the other hand, in a case of t52 when the fault is diagnosed based on the fixed reference value R1, the difference between the state value of the driving model and the driving information does not exceed the reference value, and thus, it is not determined that the fault has occurred.

When the controller 120 diagnoses a failure based on the learning reference value R2, the controller 120 determines that the failure occurs because the difference between the driving model and the state value of the driving information exceeds the reference value.

As described above, it is possible to accurately and reliably determine a failure by applying the reference value used for diagnosing a failure over time through machine learning.

On the other hand, FIG. 5 is only one embodiment for explaining the operation of the present disclosure and there is no limitation to the operation for diagnosing the failure through the machine learning.

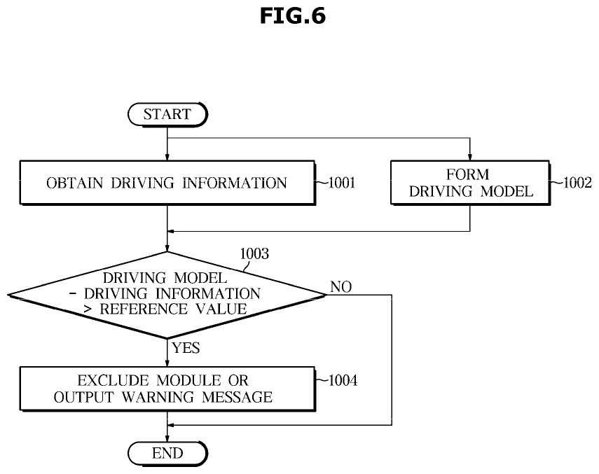

FIG. 6 is a flowchart according to an exemplary embodiment of the present disclosure.

Referring to FIG. 6, the controller 120 may derive vehicle driving information based on the signal acquired by the controller 120 (1001).

In addition, at least one of the modules provided in the vehicle may form the driving model of the vehicle (1002).

The controller 120 may derive the difference between the driving model and the driving information (1003).

When the difference between the driving model and the driving information exceeds the reference value, it may be determined that a failure occurs in the module forming the driving model.

The controller 120 may exclude the module from driving or transmit a warning message through the display 130 (1004).

The embodiments as described above may be embodied in the form of a recording medium to store commands that can be executed by a computer. The commands may be stored in the form of program codes, and can create a program module, when executed by the processor, to perform the operations of the above-described embodiments. The recording medium may be embodied as a computer-readable recording medium.

The computer-readable recording medium may be or include any kind of recording device to store commands that can be interpreted by a computer. For example, the computer-readable recording medium may be ROM, RAM, a magnetic tape, a magnetic disk, flash memory, or an optical data storage device.

For the vehicle and the control method thereof according to the embodiments of the present disclosure, by recognizing the driving situation of the vehicle upon autonomous driving, and controlling the components of the vehicle when a dangerous situation is sensed, safe autonomous driving is possible.

Although various embodiments of the present disclosure have been shown and described herein, it should be appreciated by those having ordinary skill in the art that changes may be made in the disclosed embodiments without departing from the principles and spirit of the disclosure, the scope of which is defined in the claims and their equivalents.

What is claimed is:

1. A vehicle comprising:
at least one module configured to determine a driving model of the vehicle;
a sensor configured to obtain driving information of the vehicle; and
a controller configured to:
determine the driving information corresponding to the driving model, and
determine whether the at least one module has failed or not based on a comparison of a reference value and a difference between the driving model and the driving information.

2. The vehicle of claim 1, further comprising a display,
wherein the controller is configured to output a message to the display when determined that a failure occurs in the at least one module.

3. The vehicle of claim 1, wherein the at least one module comprises an Around View Monitor (AVM) module, and
wherein the controller is configured to determine whether the AVM module has failed based on a comparison between each of a lateral acceleration and a yaw rate of a driving model determined by the AVM module and a lateral acceleration and a yaw rate included in the driving information.

4. The vehicle of claim 1, wherein the at least one module comprises a Global Positioning System (GPS) module, and
wherein the controller is configured to determine whether the GPS module has failed based on a comparison between each of a longitudinal speed and a yaw angle of a driving model determined by the GPS module and a longitudinal speed and a yaw angle included in the driving information.

5. The vehicle of claim 1, wherein the sensor comprises a wheel speed sensor and an inertial sensor.

6. The vehicle of claim 1, wherein the reference value is determined based on variable values of the driving information corresponding to the driving model

7. The vehicle of claim 1, wherein the sensor comprises a plurality of sensor modules, and
wherein the controller is configured to determine the driving information by comparing a first state variable determined based on at least one of the plurality of sensor modules and a second state variable determined based on a remaining one or more of the plurality of sensor modules.

8. The vehicle of claim 1, wherein the controller is configured to drive the vehicle excluding the driving model generated by the at least one module when determined that a failure has occurred in the at least one module.

9. A control method of a vehicle comprising:
determining a driving model of the vehicle;
obtaining driving information of the vehicle;
determining the driving information corresponding to the driving model; and
determining whether at least one module has failed or not based on a comparison of a reference value and a difference between the driving model and the driving information.

10. The control method of claim 9 further comprising outputting a message to a display when determined that a failure occurs in the at least one module.

11. The control method of claim 9, wherein the at least one module comprises an Around View Monitor (AVM) module, and
wherein the determining whether at least one module has failed comprises determining whether the AVM module has failed based on a comparison between each of a lateral acceleration and a yaw rate of a driving model determined by the AVM module and a lateral acceleration and a yaw rate included in the driving information.

12. The control method of claim 9, wherein the at least one module comprises a Global Positioning System (GPS) module, and
wherein the determining of whether at least one module has failed comprises determining whether the GPS module has failed based on a comparison between each of a longitudinal speed and a yaw angle of a driving model determined by the GPS module and a longitudinal speed and a yaw angle included in the driving information.

13. The control method of claim 9, wherein the reference value is determined based on variable values of the driving information corresponding to the driving model.

14. The control method of claim 9, wherein the determining of whether at least one module has failed comprises determining the driving information by comparing a first state variable determined based on at least one of a plurality of sensor modules and a second state variable determined based on a remaining one or more of the plurality of sensor modules.

15. The control method of claim 9, further comprising driving the vehicle excluding the driving model generated by the at least one module when determined that a failure has occurred in the at least one module.
